(19) United States
(12) Patent Application Publication
(10) Pub. No.: US 2025/0078749 A1
(43) Pub. Date: Mar. 6, 2025

(54) PIXEL CIRCUIT, DRIVING METHOD, DISPLAY SUBSTRATE, DISPLAY PANEL, AND DISPLAY DEVICE

(71) Applicant: BOE TECHNOLOGY GROUP CO., LTD., Beijing (CN)

(72) Inventors: Ying HAN, Beijing (CN); Pan XU, Beijing (CN); Xing ZHANG, Beijing (CN); Chengyuan LUO, Beijing (CN); Donghui ZHAO, Beijing (CN); Guangshuang LV, Beijing (CN); Cheng XU, Beijing (CN)

(73) Assignee: BOE TECHNOLOGY GROUP CO., LTD., Beijing (CN)

(21) Appl. No.: 18/558,143

(22) PCT Filed: Nov. 24, 2022
(86) PCT No.: PCT/CN2022/133989

§ 371 Date: Oct. 30, 2023

(51) Int. Cl. G09G 3/3233

(52) U.S. Cl. CPC G09G 3/3233; G09G 2300/0426; G09G 2300/0819; G09G 2300/0842; G09G 2300/0861; G09G 2310/08

(57) ABSTRACT

Pixel circuit, driving method, display substrate, panel and device are disclosed. The pixel circuit includes light-emitting element, and pixel driving circuit including driving circuit, data writing circuit and compensation control circuit; the data writing circuit writes data voltage into control end of driving circuit under control of write control signal in data writing phase; the compensation control circuit writes reference voltage into the control end of driving circuit under control of compensation control signal in compensation phase; the driving circuit is electrically connected to the light-emitting element, and is configured to drive the light-emitting element; the data writing phase does not overlap with the compensation phase. The threshold voltage compensation process does not occupy data writing time in timing, potential of source electrode of the driving transistor included in the driving circuit can be charged to theoretical target potential, which is applicable to display products with high refresh rate.

### TECHNICAL FIELD

The present disclosure relates to the field of displaying technology, and in particular, to a pixel circuit, a driving method, a display substrate, a display panel, and a display device.

### BACKGROUND

For display products with medium size, when compared with the external compensation technique, the internal compensation technique has following advantages: driving system is simple; low cost; no need for expensive FPGA (Field Programmable Gate Array) or ASIC (Application Specific Integrated Circuit) chip and external compensation source driver (source electrode driver); no need for bulky tcon (timing controller) board; driving products with simple appearance. However, when compared with the extra compensation pixel circuit, the pixel driving circuit with the oxide type internal compensation is more complicated in the pixel driving portion and the compensation time is longer.

### SUMMARY

In an aspect, an embodiment of the present disclosure provides a pixel circuit, which includes a light-emitting element and a pixel driving circuit; the pixel driving circuit includes a driving circuit, a data writing circuit and a compensation control circuit.

The data writing circuit is electrically connected to a write control line, a data line and a control end of the driving circuit. The data writing circuit is configured to write a data voltage provided by the data line into the control end of the driving circuit under control of a write control signal provided by the write control line in a data writing phase.

The compensation control circuit is electrically connected to a compensation control line, a reference voltage line and the control end of the driving circuit. The compensation control circuit is configured to write a reference voltage provided by the reference voltage line into the control end of the driving circuit under control of a compensation control signal provided by the compensation control line in a compensation phase.

The driving circuit is electrically connected to the light-emitting element, and is configured to drive the light-emitting element.

The data writing phase does not overlap with the compensation phase.

Optionally, the pixel driving circuit further includes a light-emitting control circuit.

The light-emitting control circuit is electrically connected to a light-emitting control line, a first end of the driving circuit and a first voltage line. The light-emitting control circuit is configured to control a connection between the first end of the driving circuit and the first voltage line under control of a light-emitting control signal provided by the light-emitting control line.

A second end of the driving circuit is electrically connected to a first electrode of the light-emitting element, and a second electrode of the light-emitting element is electrically connected to a second voltage line.

Optionally, the pixel driving circuit further includes a reset circuit.

The reset circuit is electrically connected to a reset control line, an initial voltage line and the second end of the driving circuit, and is configured to write an initial voltage provided by the initial voltage line into the second end of the driving circuit under control of a reset control signal provided by the reset control line in a reset phase.

Optionally, at least a portion of a time period during which the light-emitting control circuit controls the first end of the driving circuit to be connected to the first voltage line does not overlap with the reset phase.

Optionally, the pixel driving circuit further includes an energy storage circuit.

A first end of the energy storage circuit is electrically connected to the control end of the driving circuit, a second end of the energy storage circuit is electrically connected to the second end of the driving circuit, and the energy storage circuit is configured to store electric energy.

Optionally, the data writing circuit includes a first transistor, the compensation control circuit includes a second transistor, the reset circuit includes a third transistor, the light-emitting control circuit includes a fourth transistor, the driving circuit includes a driving transistor, and the energy storage circuit includes a storage capacitor; the light-emitting element includes an organic light-emitting diode.

A gate electrode of the first transistor is electrically connected to the write control line, a first electrode of the first transistor is electrically connected to the data line, and a second electrode of the first transistor is electrically connected to a gate electrode of the driving transistor.

A gate electrode of the second transistor is electrically connected to the compensation control line, a first electrode of the second transistor is electrically connected to the reference voltage line, and a second electrode of the second transistor is electrically connected to the gate electrode of the driving transistor.

A gate electrode of the third transistor is electrically connected to the reset control line, a first electrode of the third transistor is electrically connected to the initial voltage line, and a second electrode of the third transistor is electrically connected to a second electrode of the driving transistor.

A gate electrode of the fourth transistor is electrically connected to the light-emitting control line, a first electrode of the fourth transistor is electrically connected to the first voltage line, and a second electrode of the fourth transistor is electrically connected to a first electrode of the driving transistor.

The second electrode of the driving transistor is electrically connected to an anode of the organic light-emitting diode, and a cathode of the organic light-emitting diode is electrically connected to the second voltage line.

A first plate of the storage capacitor is electrically connected to the gate electrode of the driving transistor, and a second plate of the storage capacitor is electrically connected to the second electrode of the driving transistor.

In a second aspect, an embodiment of the present disclosure provides a driving method, applied to the above-described pixel circuit, the driving method includes:
writing, in the data writing phase by the data writing circuit, the data voltage provided by the data line into the control end of the driving circuit under control of the write control signal; and
writing, in the compensation phase by the compensation control circuit, the reference voltage provided by the reference voltage line into the control end of the driving circuit under control of the compensation control signal; and
driving, by the driving circuit, the light-emitting element;
where the data writing phase does not overlap with the compensation phase.

Optionally, the displaying period further includes a light-emitting phase arranged after the data writing phase and the compensation phase; the pixel driving circuit further includes a light-emitting control circuit; and the driving method includes:
controlling, in the light-emitting phase by the light-emitting control circuit, a first end of the driving circuit to be connected to a first voltage line under control of a light-emitting control signal;
where in the light-emitting phase, the light-emitting control signal is a pulse width modulation (PWM) signal.

In a third aspect, embodiments of the present disclosure provide a display substrate, including a plurality of rows of pixel circuits and a plurality of columns of pixel circuits disposed on the base substrate, each pixel circuit of which is the pixel circuit as described above.

Optionally, an orthographic projection of a first electrode of a light-emitting element included in the pixel circuit onto the base substrate covers an orthographic projection of at least part of elements included in the pixel driving circuit of the pixel circuit onto the base substrate.

Optionally, the display substrate according to at least one embodiment of the present disclosure further includes a plurality of direct current signal lines arranged on the base substrate; the direct current signal line extends in a first direction.

At least one direct current signal line of the plurality of direct current signal lines is provided between pixel driving circuits included in two adjacent pixel circuits in a second direction.

The first direction intersects with the second direction.

Optionally, the orthographic projection of the first electrode of the light-emitting element onto the base substrate covers an orthographic projection of the at least one direct current signal line onto the base substrate.

Optionally, according to at least one embodiment of the present disclosure, the display substrate further includes a plurality of data lines arranged on the base substrate; the data lines extend in the first direction.

A data line of the plurality of data lines is provided between pixel driving circuits included in two adjacent pixel circuits in the second direction.
the orthographic projection of the first electrode of the light-emitting element onto the base substrate does not cover an orthographic projection of the data line onto the base substrate.

Optionally, signals on signal lines, located at a first side of pixel driving circuits of pixel circuits corresponding to a same color and being closest to the pixel driving circuits, have a same type, and signals on signal lines, located at a second side of the pixel driving circuits of the pixel circuits corresponding to the same color and being closest to the pixel driving circuits, have a same type.

The first side and the second side are opposite sides.

Optionally, the pixel driving circuit includes a reset circuit, and the reset circuit includes a third transistor.

The first electrode of the light-emitting element is electrically connected to a second electrode of the third transistor through via holes.
a maximum length of at least one of the via holes in the second direction is greater than a maximum length of the second electrode of the third transistor in the second direction.

Optionally, the display substrate includes a source and drain metal layer, a first insulating layer, a second insulating layer and a first electrode layer which are arranged sequentially in a direction away from the base substrate.

The first electrode of the light-emitting element is formed in the first electrode layer, and the second electrode of the third transistor is formed in the source and drain metal layer.

The second electrode of the third transistor is electrically connected to the first electrode of the light-emitting element via a first via hole penetrating through the first insulating layer and a second via hole penetrating through the second insulating layer successively.

An orthographic projection of the first via hole onto the base substrate is within an orthographic projection of the second via hole onto the base substrate.

A maximum length of the second via hole in the second direction is greater than a maximum length of the second electrode of the third transistor in the second direction.

Optionally, transistors included in pixel driving circuits of pixel circuits corresponding to a same color have a same structure, and storage capacitors included in the pixel driving circuits of the pixel circuits corresponding to the same color have a same structure.

Optionally, according to at least one embodiment of the present disclosure, the display substrate further includes a plurality of first reference voltage lines extending in the second direction, and a plurality of second reference voltage lines extending in the first direction which are arranged on the base substrate.

The first reference voltage line is electrically connected to the second reference voltage line through a connecting conductive pattern located in a same conductive layer.

Optionally, according to at least one embodiment of the present disclosure, the display substrate further includes a plurality of transverse power supply voltage lines and a plurality of longitudinal power supply voltage lines arranged on the base substrate; the plurality of transverse power supply voltage lines and the plurality of longitudinal power supply voltage lines are electrically connected to each other; and the plurality of transverse power supply voltage lines and the plurality of longitudinal power supply voltage lines are formed in different metal layers.

The display substrate further includes a plurality of transverse reference voltage lines and a plurality of longitudinal reference voltage lines arranged on the base substrate, where the plurality of transverse reference voltage lines and the plurality of longitudinal reference voltage lines are electrically connected to each other; and the plurality of transverse reference voltage lines and the plurality of longitudinal reference voltage lines are formed in different metal layers.

Optionally, the display substrate further includes a plurality of transverse initial voltage lines and a plurality of longitudinal initial voltage lines arranged on the base substrate; the plurality of transverse initial voltage line and the plurality of longitudinal initial voltage line are formed in different metal layers.

One column of pixel structures includes three columns of pixel circuits, and one column of pixel structures share one longitudinal initial voltage line; one group of pixel structures includes at least one column of pixel circuits.
each row of pixel circuits in one group of pixel structures is electrically connected to a same transverse initial voltage line, and a longitudinal initial voltage line shared by the one group of pixel structures is electrically connected to a plurality of transverse initial voltage lines to which the one group of pixel structures is electrically connected.

Optionally, the pixel circuit includes a storage capacitor; a second plate of the storage capacitor includes a first plate portion and a second plate portion.

In a direction perpendicular to the base substrate, at least a portion of the first plate of the storage capacitor is located between the first plate portion and the second plate portion.

Optionally, the display substrate includes a first electrode layer and a pixel definition layer which are arranged sequentially in a direction away from the base substrate; the display substrate further includes a dummy pixel circuit arranged on the base substrate; the dummy pixel circuit includes a dummy organic light-emitting diode.

Openings included in the pixel definition layer does not expose an anode of the dummy organic light-emitting diode, the anode of the dummy organic light-emitting diode e is formed in the first electrode layer.

Alternatively, the dummy pixel circuit does not include an anode pattern.

Alternatively, the dummy pixel circuit further includes at least one transistor; and the anode of the dummy organic light-emitting diode is not electrically connected to a transistor included in the dummy pixel circuit.

In a fourth aspect, embodiments of the present disclosure provide a display panel, including the display substrate as described above.

Optionally, the display substrate includes a plurality of write control lines, a plurality of compensation control lines, a plurality of light-emitting control lines and a plurality of reset control lines.

At least two rows of pixel circuits included in the display substrate share one compensation control line, the at least two rows of pixel circuits share one light-emitting control line, and the at least two rows of pixel circuits share one reset control line.

In a fifth aspect, embodiments of the present disclosure provide a display device, including the above-described display panel.

### BRIEF DESCRIPTION OF THE DRAWINGS

FIG. 1 is a structural diagram of a pixel circuit according to an embodiment of the present disclosure;

FIG. 2 is a structural diagram of a pixel circuit according to at least one embodiment of the present disclosure;

FIG. 3 is a circuit diagram of a pixel circuit according to at least one embodiment of the present disclosure;

FIG. 4 is an operational timing diagram for the pixel circuit shown in FIG. 3 according to at least one embodiment;

FIG. 5 is a schematic diagram of a display substrate including six pixel driving circuits according to an embodiment of the present disclosure;

FIG. 6 is a schematic diagram of an anode pattern disposed on the upper side of the structure of FIG. 5;

FIG. 7 is a layout diagram of a pixel driving circuit according to at least one embodiment;

FIG. 8 is a layout diagram of a light-shielding layer in FIG. 7;

FIG. 9 is a layout diagram of a semiconductor layer in FIG. 7;

FIG. 10 is a layout diagram of a gate metal layer of FIG. 7;

FIG. 11 is a layout diagram of a source and drain metal layer of FIG. 7;

FIG. 12 is a layout diagram in which a first electrode layer is disposed on the basis of FIG. 11;

FIG. 13 is a schematic diagram of via holes;

FIG. 14 is a schematic diagram for arranging openings contained in a pixel definition layer on the basis of FIG. 12;

FIG. 15 is a structural diagram of a dummy pixel circuit according to at least one embodiment;

FIG. 16 is a structural diagram of a dummy pixel circuit according to at least one embodiment;

FIG. 17 is a structural diagram of a dummy pixel circuit according to at least one embodiment;

FIG. 18 is an operational timing diagram in at least one embodiment of the present disclosure for a pixel circuit according to at least one embodiment;

FIG. 19 is an operational timing diagram in at least one embodiment of the present disclosure for a pixel circuit according to at least one embodiment; and

FIG. 20 is an operational timing diagram in at least one embodiment of the present disclosure for a pixel circuit according to at least one embodiment.

### DETAILED DESCRIPTION

Embodiments of the present disclosure will now be described in detail hereinafter with reference to the accompanying drawings, in which some, but not all embodiments of the disclosure are described. Based on the embodiments in the present disclosure, all other embodiments obtained by a person of ordinary skill in the art without creative effort fall within the scope of the present disclosure.

Transistors used in all embodiments of the present disclosure may be thin film transistors or field effect transistors, or other devices with the same characteristics. In embodiments of the present disclosure, to distinguish two electrodes of a transistor other than the gate electrode, one of the two electrodes is referred to as a first electrode while the other one is referred to as a second electrode.

In practical operation, when the transistor is the thin film transistor or the field effect transistor, the first electrode may be a drain electrode, and the second electrode may be a source electrode; alternatively, the first electrode may the source electrode, and the second electrode may be the drain electrode.

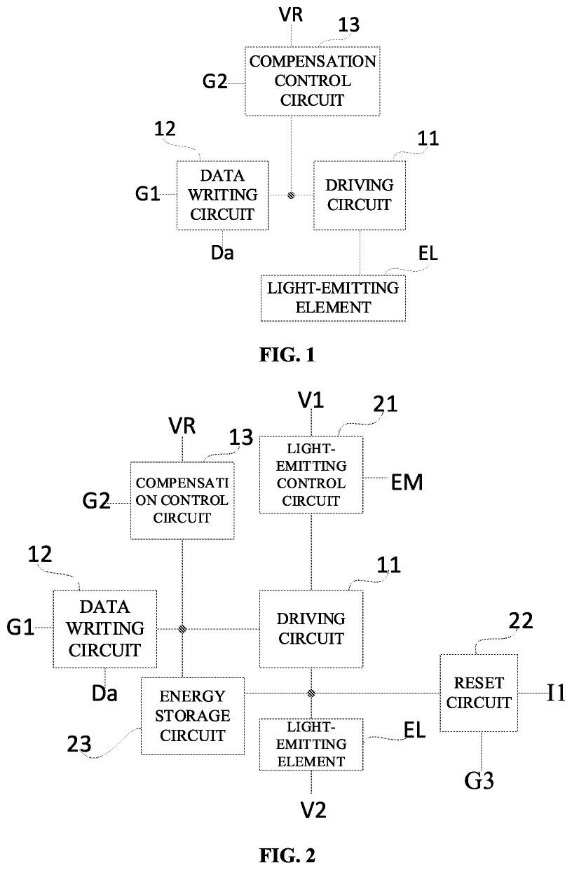

As shown in FIG. 1, according to an embodiment of the present disclosure, a pixel circuit includes a light-emitting element EL and a pixel driving circuit. The pixel driving circuit includes a driving circuit 11, a data writing circuit 12 and a compensation control circuit 13.

The data writing circuit 12 is electrically connected to a write control line G1, a data line Da and a control end of the driving circuit 11. The data writing circuit 12 is configured to write a data voltage Vdata provided by the data line Da into the control end of the driving circuit 11 under control of a write control signal provided by the write control line G1 in a data writing phase.

The compensation control circuit 13 is electrically connected to a compensation control line G2, a reference voltage line VR and the control end of the driving circuit 11. The compensation control circuit 13 is configured to write a reference voltage Vref provided by the reference voltage line VR into the control end of the driving circuit 11 under control of a compensation control signal provided by the compensation control line G2 in a compensation phase.

The driving circuit 11 is electrically connected to the light-emitting element EL and is configured to drive the light-emitting element EL.

The data writing phase does not overlap with the compensation phase.

According to the embodiment of the present disclosure, the pixel circuit includes the light-emitting element and the pixel driving circuit, and the pixel driving circuit includes the driving circuit, the data writing circuit and the compensation control circuit. In the data writing phase, the data writing circuit writes the data voltage into the control end of the driving circuit under control of the write control signal, while in the compensation phase, the compensation control circuit writes the reference voltage into the control end of the driving circuit under control of the compensation control signal, where the data writing phase and the compensation phase do not overlap with each other, such that in a timing sequence, a threshold voltage compensation process does not occupy time for data writing, and a potential at a source electrode of a driving transistor included in the driving circuit can be charged to a theoretical target potential. Such a pixel circuit is more applicable to a display product with higher refresh frequency.

In at least one embodiment of the present disclosure, the pixel driving circuit further includes a light-emitting control circuit.

The light-emitting control circuit is electrically connected to a light-emitting control line, a first end of the driving circuit and a first voltage line. The light-emitting control circuit is configured to control the first end of the driving circuit to be connected to the first voltage line under control of a light-emitting control signal provided by the light-emitting control line.

A second end of the driving circuit is electrically connected to a first electrode of the light-emitting element, and a second electrode of the light-emitting element is electrically connected to a second voltage line.

In specific implementations, the pixel driving circuit may further include the light-emitting control circuit which, under control of the light-emitting control signal, controls the connection between the first end of the driving circuit and the first voltage line.

Optionally, the first voltage line may be a power supply voltage line and the second voltage line may be a low voltage line, but this is not limiting.

In at least one embodiment of the present disclosure, the pixel driving circuit further includes a reset circuit.

The reset circuit is electrically connected to a reset control line, an initial voltage line and the second end of the driving circuit. In a reset phase, the reset circuit is configured to write an initial voltage provided by the initial voltage line into the second end of the driving circuit under control of a reset control signal provided by the reset control line.

In specific implementations, the pixel driving circuit may further include the reset circuit, the reset circuit writes the initial voltage to the second end of the driving circuit under the control of the reset control signal in the reset phase, the second end of the driving circuit is electrically connected to the first electrode of the light-emitting element to remove residual charges at the first electrode of the light-emitting element.

Optionally, the light-emitting control circuit controls at least a portion of a time period, during which the first end of the driving circuit is connected to the first voltage line, does not overlap with the reset phase.

In at least one embodiment of the present disclosure, a duration of the reset phase, during which the light-emitting control circuit controls the first end of the driving circuit to be disconnected from the first voltage line, is relatively long, which can ensure a maximum consistency of the potential at the source electrode of the driving transistor with the initial voltage, while prevent a duration during which the first voltage line is connected to the initial voltage line from being too long.

In at least one embodiment of the present disclosure, the pixel driving circuit further includes an energy storage circuit.

A first end of the energy storage circuit is electrically connected to the control end of the driving circuit, a second end of the energy storage circuit is electrically connected to the second end of the driving circuit, and the energy storage circuit is configured to store electric energy.

As shown in FIG. 2, on the basis of the pixel circuit of the embodiment shown in FIG. 1, the pixel driving circuit further includes a light-emitting control circuit 21, a reset circuit 22 and an energy storage circuit 23.

The light-emitting control circuit 21 is electrically connected to a light-emitting control line EM, a first end of the driving circuit 11 and a first voltage line V10. The light-emitting control circuit 21 is configured to control a connection between the first end of the driving circuit 11 and the first voltage line V1 under the control of a light-emitting control signal provided by the light-emitting control line EM.

A second end of the driving circuit 11 is electrically connected to a first electrode of the light-emitting element EL, and a second electrode of the light-emitting element EL is electrically connected to a second voltage line V2.

The reset circuit 22 is electrically connected to a reset control line G3, an initial voltage line I1 and a second end of the driving circuit 11. In a reset phase, the reset circuit 22 is configured for writing an initial voltage Vini provided by the initial voltage line I1 into the second end of the driving circuit 11 under the control of a reset control signal provided by the reset control line G3.

A first end of the energy storage circuit 23 is electrically connected to a control end of the driving circuit 11, a second end of the energy storage circuit 23 is electrically connected to a second end of the driving circuit 11, and the energy storage circuit 23 is configured for storing electric energy.

Optionally, the data writing circuit includes a first transistor, the compensation control circuit includes a second transistor, the reset circuit includes a third transistor, the light-emitting control circuit includes a fourth transistor, the driving circuit includes a driving transistor, and the energy storage circuit includes a storage capacitor; the light-emitting element includes an organic light-emitting diode.

A gate electrode of the first transistor is electrically connected to the write control line, a first electrode of the first transistor is electrically connected to the data line, and a second electrode of the first transistor is electrically connected to a gate electrode of the driving transistor.

A gate electrode of the second transistor is electrically connected to the compensation control line, a first electrode of the second transistor is electrically connected to the reference voltage line, and a second electrode of the second transistor is electrically connected to the gate electrode of the driving transistor.

A gate electrode of the third transistor is electrically connected to the reset control line, a first electrode of the third transistor is electrically connected to the initial voltage line, and a second electrode of the third transistor is electrically connected to a second electrode of the driving transistor.

A gate electrode of the fourth transistor is electrically connected to the light-emitting control line, a first electrode of the fourth transistor is electrically connected to the first voltage line, and a second electrode of the fourth transistor is electrically connected to a first electrode of the driving transistor.

The second electrode of the driving transistor is electrically connected to an anode of the organic light-emitting diode, and a cathode of the organic light-emitting diode is electrically connected to the second voltage line.

A first plate of the storage capacitor is electrically connected to the gate electrode of the driving transistor, and a second plate of the storage capacitor is electrically connected to the second electrode of the driving transistor.

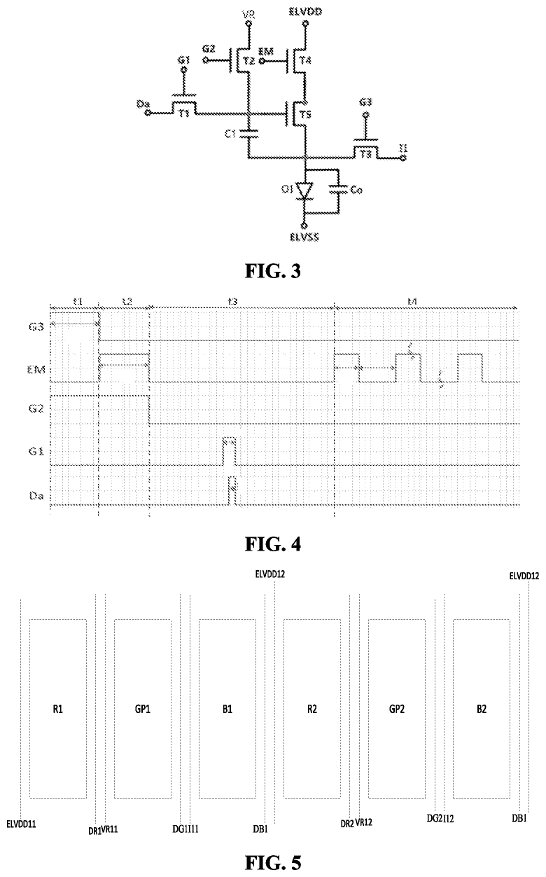

As shown in FIG. 3, on the basis of the pixel circuit in at least one embodiment shown in FIG. 2, the data writing circuit includes a first transistor T1, the compensation control circuit includes a second transistor T2, the reset circuit includes a third transistor T3, the light-emitting control circuit includes a fourth transistor T4, the driving circuit includes a driving transistor T5, and the energy storage circuit includes a storage capacitor C1; the light-emitting element includes an organic light-emitting diode O1.

A gate electrode of the first transistor T1 is electrically connected to a write control line G1, a first electrode of the first transistor T1 is electrically connected to a data line Da, and a second electrode of the first transistor T1 is electrically connected to a gate electrode of the driving transistor T5.

A gate electrode of the second transistor T2 is electrically connected to a compensation control line G2, a first electrode of the second transistor T2 is electrically connected to a reference voltage line VR, and a second electrode of the second transistor T2 is electrically connected to the gate electrode of the driving transistor T5.

A gate electrode of the third transistor T3 is electrically connected to a reset control line G3, a first electrode of the third transistor T3 is electrically connected to an initial voltage line I1, and a second electrode of the third transistor T3 is electrically connected to a second electrode of the driving transistor T5.

A gate electrode of the fourth transistor T4 is electrically connected to a light-emitting control line EM, a first electrode of the fourth transistor T4 is electrically connected to a power supply voltage line ELVDD, and a second electrode of the fourth transistor T4 is electrically connected to a first electrode of the driving transistor T5.

The second electrode of the driving transistor T5 is electrically connected to an anode of the organic light-emitting diode O1, and a cathode of the organic light-emitting diode O1 is electrically connected to a low voltage line ELVSS.

A first plate of the storage capacitor C1 is electrically connected to the gate electrode of the driving transistor T5, and a second plate of the storage capacitor C1 is electrically connected to the second electrode of the driving transistor T5.

In FIG. 3, a reference sign Co denotes a parasitic capacitor of element O1.

In the pixel circuit of at least one embodiment shown in FIG. 3, all transistors may be n-type transistors, but this is not a limitation.

As shown in FIG. 4, when the pixel circuit of at least one embodiment of shown in FIG. 3 is in operation, a displaying period includes a reset phase t1, a compensation phase t2, a data writing phase t3 and a light-emitting phase t4 arranged in the sequence listed.

In the reset phase t1, G2 provides a high voltage signal, G3 provides a high voltage signal, and T2 is switched on and T3 is switched on. The reference voltage Vref provided by the reference voltage line VR is written into the gate electrode of T5, and the initial voltage Vini provided by the initial voltage line I1 is written into a source electrode of T5, so that at the beginning of the compensation phase t2, T5 can be switched on; EM and G1 provide low voltage signals.

In the compensation phase t2, G2 continues to provide a high voltage signal, EM provides a high voltage signal, G3 provides a low voltage signal, G1 provides a low voltage signal, T2 is switched on, the gate voltage of T5 is maintained as Vref, and T4 is switched on.

At the beginning of the compensation phase t2, T5 is switched on, and C1 is charged by the power supply voltage so as to raise the potential at the source electrode of T5, until a gate-source voltage of T5 reaches Vth, T5 is switched off to stop the charging. At this time, the potential at the source electrode of T5 is Vref-Vth, where Vth is the threshold voltage of T5. A difference between the voltage value of the Vref-Vth and the voltage value of the low voltage signal provided by the low voltage line ELVSS is less than the lighting voltage of O1.

In the data writing phase t3, G3 provides a low voltage signal, EM provides a low voltage signal, and G2 provides a low voltage signal.

During a corresponding row data writing time period included the data writing phase t3, G1 provides a high voltage signal, T1 is switched on, and the data line Da provides data voltage Data to the gate electrode of T5.

In the light-emitting phase t4, each of G1, G2 and G3 provides a low voltage signal.

During a light-emitting time period included in the light-emitting phase t4, EM provides a high voltage signal, T4 and T5 are switched on, the potential at the source electrode of T5 is charged to Voled (Voled is the lighting voltage of O1), and O1 emits light.

When the display panel has a high demand for low-gray-scale display, a PWM (pulse width modulation) dimming mode can be used to improve the display effect of the low-gray-scale. That is to say, in the light-emitting phase, a larger pixel drive current used, and in combination with the PWM dimming, the display brightness of the display panel is adjusted by controlling the time length of light-emitting. As shown in FIG. 4, in the light-emitting phase t4, the light-emitting control signal is a PWM signal, and a period of the light-emitting control signal and a duty ratio of the light-emitting control signal may be adjusted according to the actual displaying situation.

In at least one embodiment of the present disclosure, since the reset phase t1 has a relatively long duration, during which EM provides a low voltage signal, it is possible to ensure the voltage at the source electrode of the driving transistor T5 to be consistent with Vini to a greater extent, while preventing ELVDD from being connected to the initial voltage line for a long time. During the data writing phase t3, EM provides a low voltage signal to maintain the written Vgs (Vgs is the gate-source voltage of the driving transistor T5).

When the pixel circuit as disclosed in at least one embodiment of the present disclosure is in operation, in the compensation phase, G3 provides a high voltage signal and T3 is switched on to control the anode of O1 to connect to the Vini to clear residual charges at the anode of O1.

In at least one embodiment of the present disclosure, G2, G3, and EM may be shared or by multiple rows or not shared. When G2, G3 and EM are shared by multiple rows, the multiple rows of pixel circuits are reset and voltage-compensated at the same time, and after writing the data voltage row by row, the light-emitting control line is switched on, and the multiple rows of pixel circuits emit light at the same time. In the data writing phase, the switched-off time of the light-emitting control line can be adjusted according to a sharing situation, so as to ensure that all of the rows of pixel circuits emit light together after the data voltage have been written into all of the rows of pixel circuits.

As described above, in low-gray-scale displaying, the uniformity of the display panel is poor, and the low-gray-scale displaying effect can be improved with the current plus PWM dimming mode. Simulations in which the PWM dimming is not performed, the PWM dimming with a duty ratio of 30% is performed, and the PWM dimming with a duty ratio of 20% are performed respectively, to obtain corresponding threshold voltage uniformity compensation effects of the display panel.

For example, in a case that a maximum absolute value of a difference between threshold voltages of driving transistors in different pixel circuits included in the display panel is about 1V,

when the display brightness is 11 nits, and if there is no PWM dimming, the display uniformity is 84%; if the PWM dimming with the duty ratio of 30% is performed, the display uniformity is 87.2%; and if the PWM dimming with the duty ratio of 20% is performed, the display uniformity is 89.5%;

when the display brightness is 32 nits, and if there is no PWM dimming, the display uniformity is 86.6%; if the PWM dimming with the duty ratio of 30% is performed, the display uniformity is 92.8%; and if the PWM dimming with the duty ratio of 20% is performed, the display uniformity is 94.4%;

when the display brightness is 150 nits, and if there is no PWM dimming, the display uniformity is 94.2%; if the PWM dimming with the duty ratio of 30% is performed, the display uniformity is 96.7%; and if the PWM dimming with the duty ratio of 20% is performed, the display uniformity is 97.2%;

when the display brightness is 220 nits, and if there is no PWM dimming, the display uniformity is 95.2%; if the PWM dimming with the duty ratio of 30% is performed, the display uniformity is 97.2%; and if the PWM dimming with the duty ratio of 20% is performed, the display uniformity is 97.6%.

For another example, in a case that a maximum absolute value of a difference between threshold voltages of driving transistors in different pixel circuits included in the display panel is about 2V,

when the display brightness is 11 nits, and if there is no PWM dimming, the display uniformity is 63.1%; if the PWM dimming with the duty ratio of 30% is performed, the display uniformity is 74.9%; and if the PWM dimming with the duty ratio of 20% is performed, the display uniformity is 79.1%;

when the display brightness is 32 nits, and if there is no PWM dimming, the display uniformity is 73.9%; if the PWM dimming with the duty ratio of 30% is performed, the display uniformity is 85.8%; and if the PWM dimming with the duty ratio of 20% is performed, the display uniformity is 88.8%;

when the display brightness is 150 nits, and if there is no PWM dimming, the display uniformity is 88.4%; if the PWM dimming with the duty ratio of 30% is performed, the display uniformity is 93.3%; and if the PWM dimming with the duty ratio of 20% is performed, the display uniformity is 94.4%;

when the display brightness is 220 nits, and if there is no PWM dimming, the display uniformity is 90.5%; if the PWM dimming with the duty ratio of 30% is performed, the display uniformity is 94.3%; and if the PWM dimming with the duty ratio of 20% is performed, the display uniformity is 95.4%.

According to an embodiment of the present disclosure, a driving method, applied to the above-mentioned pixel circuit, includes:
writing, in a data writing phase by a data writing circuit, a data voltage provided by a data line into a control end of a driving circuit under control of a write control signal; and
writing, in a compensation phase by a compensation control circuit, a reference voltage provided by a reference voltage line into the control end of the driving circuit under control of a compensation control signal; and driving, by the driving circuit, a light-emitting element;
where the data writing phase does not overlap with the compensation phase.

In the driving method according to the embodiment of the present disclosure, the data writing circuit writes the data voltage into the control end of the driving circuit under control of the write control signal in the data writing phase, and the compensation control circuit writes the reference voltage into the control end of the driving circuit under control of the compensation control signal in the compensation phase, where the data writing phase and the compensation phase does not overlap with each other, such that in a timing sequence, a threshold voltage compensation process does not occupy time for data writing, and a potential at a source electrode of a driving transistor included in the driving circuit can be charged to a theoretical target potential. Such a driving method is more applicable to a display product with higher refresh frequency.

In at least one embodiment of the present disclosure, a displaying period further includes a light-emitting phase arranged after the data writing phase and the compensation phase, the pixel driving circuit further includes a light-emitting control circuit, and the driving method includes:
controlling, in the light-emitting phase by the light-emitting control circuit, a first end of the driving circuit to be connected to a first voltage line under control of a light-emitting control signal;
where in the light-emitting phase, the light-emitting control signal is a pulse width modulation (PWM) signal.

When the display panel has a high demand for low-gray-scale display, a PWM (pulse width modulation) dimming mode can be used to improve the display effect of the low-gray-scale. That is to say, in the light-emitting phase, a larger pixel drive current used, and in combination with the PWM dimming, the display brightness of the display panel is adjusted by controlling the time length of light-emitting. In the light-emitting phase, the light-emitting control signal is a PWM signal, and a period of the light-emitting control signal and a duty ratio of the light-emitting control signal may be adjusted according to the actual displaying situation.

According to an embodiment of the present disclosure, A display substrate includes a base substrate, and a plurality of rows of and a plurality of columns of pixel circuits provided on the base substrate, each of which is the pixel circuit as described above.

When compared to a pixel circuit with an external compensation, the number of TFTs (Thin-Film Transistor) and data on wirings increase in the pixel circuit with an internal compensation, and the wiring arrangement has a great influence on the driving.

In at least one embodiment of the present disclosure, an orthographic projection of a first electrode of the light-emitting element included in the pixel circuit onto the base substrate covers an orthographic projection of at least part of elements included in the pixel driving circuit of the pixel circuit onto the base substrate.

Optionally, the light-emitting element is an organic light-emitting diode, and the first electrode of the light-emitting element is an anode.

As shown in FIG. 3, the anode of the organic light-emitting diode is electrically connected to the source electrode of the driving transistor, and the anode potential of the organic light-emitting diode directly affects the threshold voltage compensation effect. The anode design of the organic light-emitting diode is therefore very important for the layout design of the pixel circuit with internal compensation.

In at least one embodiment of the present disclosure, in order to prevent the anode potential from being disturbed, an anode pattern covers the pixel driving circuit corresponding thereto, and there is no cross coverage on pixel driving circuits of adjacent pixel circuits at left and right, and on pixel driving circuits in pixel circuit at adjacent upper and lower rows. In order to avoid mutual interference between compensation signals as much as possible, the anode is designed to avoid cross-coverage on different pixel driving circuits as much as possible. Accordingly, in at least one embodiment of the present disclosure, the orthographic projection of the first electrode of the light-emitting element included in the pixel circuit onto the base substrate, is designed to cover the orthographic projection of at least some of elements of the pixel driving circuit in that pixel circuit onto the base substrate, without covering elements included in pixel driving circuit(s) in pixel circuit(s) other than that pixel circuit.

According to at least one embodiment of the present disclosure, the display substrate includes a plurality of direct current signal lines arranged on the base substrate. The direct current signal line extends in a first direction.

At least one direct current signal line is provided between pixel driving circuits included in two adjacent pixel circuits in a second direction.

The first direction intersects with the second direction.

Optionally, the first direction may be a vertical direction and the second direction may be a horizontal direction, but the present disclosure is not limited thereto.

In specific implementations, each of left and right sides of each pixel driving circuit may be separated from adjacent pixel driving circuits by a column of direct current signal line, thereby reducing a coupling interference between adjacent pixel driving circuits.

Optionally, the orthographic projection of the first electrode of the light-emitting element onto the base substrate covers an orthographic projection of the at least one direct current signal line onto the base substrate.

According to at least one embodiment of the present disclosure, the display substrate further includes a plurality of data lines arranged on the base substrate. The data lines extend in the first direction.

A data line of the plurality of data lines is provided between pixel driving circuits included in two adjacent pixel circuits in the second direction.

The orthographic projection of the first electrode of the light-emitting element onto the base substrate does not cover an orthographic projection of the data line onto the base substrate.

As shown in FIG. 5, reference sign R1 denotes a first red pixel driving circuit, reference sign GP1 denotes a first green pixel driving circuit, reference sign B1 denotes a first blue pixel driving circuit, reference sign R2 denotes a second red pixel driving circuit, reference sign GP2 denotes a second green pixel driving circuit, and reference sign B2 denotes a second blue pixel driving circuit.

A first longitudinal power supply voltage line ELVDD11 is provided at a left side of R1, a first red data line DR1 and a first longitudinal reference voltage line VR11 are sequentially arranged from left to right at a right side of R1, a first green data line DGP1 and a first longitudinal initial voltage line I11 are sequentially arranged from left to right at a right side of GP1, and a first blue data line DB1 and a second longitudinal power supply voltage line ELVDD12 are sequentially arranged from left to right on a right side of B1.

A second red data line DR2 and a second longitudinal reference voltage line VR12 are sequentially arranged from left to right at a right side of R2. A second green data line DG2 and a second longitudinal initial voltage line I12 are sequentially arranged from left to right at a right side of the GP2, and a second blue data line DB2 and a third longitudinal power supply voltage line ELVDD13 are sequentially arranged from left to right at a right side of the B2.

As shown in FIG. 5, the ELVDD11, the DR1, the VR11, the DG1, the I11, the DB1, the ELVDD12, the DR2, the VR12, the DG2, the 112, the DB2 and the ELVDD13 all extend in the vertical direction and are arranged from left to right in the horizontal direction in the sequence listed.

As can be seen from FIG. 5, a direct current signal line is provided between two adjacent pixel driving circuits.

As shown in FIG. 6, six anode patterns are provided on the basis of the structural diagram of the pixel driving circuit shown in FIG. 5. The six anode patterns include: a first anode pattern An1, a second anode pattern An2, a third anode pattern An3, a fourth anode pattern An4, a fifth anode pattern An5 and a sixth anode pattern An6.

An orthographic projection of An1 onto the base substrate covers an orthographic projection of ELVDD11 onto the base substrate and an orthographic projection of the first red pixel driving circuit R1 onto the base substrate.

An orthographic projection of An2 onto the base substrate covers an orthographic projection of VR11 onto the base substrate and an orthographic projection of the first green pixel driving circuit GP1 onto the base substrate.

An orthographic projection of An3 onto the base substrate covers an orthographic projection of I11 onto the base substrate and an orthographic projection of the first blue pixel driving circuit B1 onto the base substrate.

An orthographic projection of An4 onto the base substrate covers an orthographic projection of ELVDD12 onto the base substrate and an orthographic projection of the second red pixel driving circuit R2 onto the base substrate.

An orthographic projection of An5 onto the base substrate covers an orthographic projection of VR12 onto the base substrate and an orthographic projection of the second green pixel driving circuit GP2 onto the base substrate.

An orthographic projection of An6 onto the base substrate covers an orthographic projection of 112 onto the base substrate and an orthographic projection of the second blue pixel driving circuit B2 onto the base substrate.

As can be seen from FIG. 6, an anode pattern only covers a corresponding pixel driving circuit and a direct current signal line at the left side of the corresponding pixel driving circuit, and the orthographic projection of the anode pattern onto the base substrate does not overlap with the orthographic projection of the data line onto the base substrate. This design manner can greatly reduce the coupling influence and improve the compensation effect.

For the pixel circuit with internal compensation, the compensation process thereof includes performing threshold voltage compensation by controlling the gate voltage of the driving transistor and the source voltage of the driving transistor (the source electrode of the driving transistor is electrically connected to the anode of the organic light-emitting diode), and a voltage change at the critical node (the critical node may include the gate electrode of the driving transistor and the source electrode of the driving transistor) directly affects the compensation effect. It can be seen from the operating process of the pixel circuit with internal compensation that in some time period, the critical node is in a floating state, which is vulnerable to be interfered by another AC signal, thereby affecting the threshold voltage compensation effect. Therefore, in the layout of the pixel circuit, care should be taken to minimize the overlap between the gate electrode of the driving transistor and the AC signal line, as well as between the source electrode of the driving transistor and the AC signal line, i.e., so as to reduce the capacitance. An optimized wiring layout can avoid an interaction between pixel circuits, and the optimized wirings and via holes can achieve a higher resolution design.

In at least one embodiment of the present disclosure, signals on signal lines, which are located at a first side of pixel driving circuits of pixel circuits corresponding to a same color and are closest to the pixel driving circuits, have a same type. Signals on signal lines, which are located at a second side of the pixel driving circuits of the pixel circuits corresponding to the same color and are closest to the pixel driving circuits, have a same type.

The first side and the second side are opposite sides.

Optionally, the first side may be the left side and the second side may be the right side, but this is not limiting.

Optionally, signals on two signal lines having the same type may refers to: both of the two signal lines may be power supply voltage lines, or both of the two signal lines may be reference voltage lines; or both of the two signal lines may be initial voltage lines, or both of the signal lines may be data lines, but this is not limiting.

As shown in FIG. 5, the signal line at the left side of R1 is the first longitudinal power supply voltage line ELVDD11, and the signal lines at the right side of R1 are the first red data line DR1 and the first longitudinal reference voltage line VR11 from left to right in the sequence listed.

the signal line at the left side of R2 is the second longitudinal power supply voltage line ELVDD12, and the signal lines at the right side of R2 are the second red data line DR2 and the second longitudinal reference voltage line VR12 from left to right in the sequence listed.

It can be seen from FIG. 5 that what located at the left side of the first red pixel driving circuit R1 and the left side of the second red pixel driving circuit R2 are both reference voltage lines, and what located at the right side of the first red pixel driving circuit R1 and the right side of the second red pixel driving circuit R2 are both data lines.

Optionally, the pixel driving circuit includes a reset circuit, and the reset circuit includes a third transistor.

A first electrode of the light-emitting element is electrically connected to a second electrode of the third transistor through via holes.

a maximum length of at least one of the via holes in the second direction is greater than a maximum length of the second electrode of the third transistor in the second direction.

In at least one embodiment of the present disclosure, the second direction may be a horizontal direction, but the present disclosure is not limited thereto.

In at least one embodiment of the present disclosure, the second electrode of the third transistor may be formed in a source and drain metal layer, the first electrode of the light-emitting element may be formed in a first electrode layer, and the first electrode layer may be an anode layer, but the present disclosure is not limited thereto.

In a general design, two layers of metal connected by a via hole are required to ensure that both layers of metal are larger than the via hole size after etching is completed, i.e., the via hole should be enclosed, while the maximum size of the pattern is often limited when the pixel resolution is high. In at least one embodiment of the present disclosure, based on the requirement on resolution, a transverse dimension of the second electrode of the third transistor formed in the source and drain metal layer cannot be too large, and therefore in at least one embodiment of the present disclosure, when designing the anode bonding hole, a transverse length of the second electrode of the third transistor is less than a maximum transverse length of a via hole between the second electrode of the third transistor and the first electrode of the light-emitting element after the fabrication is completed, and a longitudinal length of the second electrode of the third transistor is greater than a maximum longitudinal length of the via hole between the second electrode of the third transistor and the first electrode of the light-emitting element. In this way, an overall space utilization rate can be improved, high resolution or complex drive pixel design requirements can be met.

Optionally, the display substrate includes a source and drain metal layer, a first insulating layer, a second insulating layer and a first electrode layer arranged in a direction away from the base substrate in the sequence listed.

The first electrode of the light-emitting element is formed in the first electrode layer, and the second electrode of the third transistor is formed in the source and drain metal layer.

The second electrode of the third transistor is electrically connected to the first electrode of the light-emitting element successively through a first via hole penetrating through the first insulating layer and a second via hole penetrating through the second insulating layer.

An orthographic projection of the first via hole onto the base substrate is within an orthographic projection of the second via hole onto the base substrate.
a maximum length of the second via hole in the second direction is greater than a maximum length of the second electrode of the third transistor in the second direction.

In at least one embodiment of the present disclosure, the first insulating layer may be a passivation layer and the second insulating layer may be an organic insulating layer.

In specific implementation, when controlling the second electrode of the third transistor formed in the source and drain metal layer to be electrically connected to the first electrode of the light-emitting element formed in the first electrode layer, a first via hole and a second via hole can be used to form joint sleeve holes for the anode, where the first insulating layer and the second insulating layer are provided between the first electrode layer and the source and drain metal layer, the first via hole is a via hole penetrating through the first insulating layer, the second via hole is a via hole penetrating through the second insulating layer, and the orthographic projection of the first via hole onto the base substrate is within the orthographic projection of the second via hole onto the base substrate. The maximum length of the second via hole in the second direction is greater than the maximum length of the second electrode of the third transistor in the second direction.

In at least one embodiment of the present disclosure, the at least one conductive layer further includes a semiconductor layer, disposed between the source and drain metal layer and the base substrate.

The display substrate further includes a third insulating layer arranged between the semiconductor layer and the source and drain metal layer. The second electrode of the third transistor is electrically connected to an active layer pattern of the third transistor through a third via hole penetrating through the third insulating layer.

The active layer pattern of the third transistor is formed in the semiconductor layer.

At least a portion of an orthographic projection of the third via hole onto the base substrate is within the orthographic projection of the first via hole onto the base substrate.

Optionally, the third insulating layer may be an interlayer dielectric layer, but the present disclosure is not limited thereto.

In specific implementations, the semiconductor layer is further provided between the source and drain metal layer and the base substrate, the third insulating layer is provided between the semiconductor layer and the source and drain metal layer, the second electrode of the third transistor is electrically connected to the active layer pattern of the third transistor formed in the semiconductor layer through the third via hole penetrating through the third insulating layer, and at least part of the orthographic projection of the third via hole onto the base substrate is within the orthographic projection of the first via hole onto the base substrate, so as to improve the overall space utilization rate.

Optionally, transistors included in pixel driving circuits of pixel circuits corresponding to a same color have a same structure, and storage capacitors included in pixel driving circuits of pixel circuits corresponding to a same color have a same structure.

The structures of pixel circuits having the same color are identical, such that the layout design can be facilitated.

According to at least one embodiment of the present disclosure, the display substrate may further include a plurality of first reference voltage lines extending in the second direction and a plurality of second reference voltage lines extending in the first direction which are provided on the base substrate.

The first reference voltage line is electrically connected to the second reference voltage line through a connecting conductive pattern located in a same conductive layer.

In specific implementations, the display substrate may include the first reference voltage lines and the second reference voltage lines arranged on the base substrate, where the first reference voltage line extends in the second direction, and the second reference voltage line extends in the first direction, and the first reference voltage line is electrically connected to the second reference voltage line via the connecting conductive pattern located in the same conductive layer, such that via holes and cross wirings can be reduced, thereby improving space utilization rate. For example, the conductive layer may be, but is not limited to, the source and drain metal layer.

In at least one embodiment of the present disclosure, the pixel circuit includes a compensation control line extending in a second direction.

The pixel driving circuit in the pixel circuit includes a first portion arranged at a third side of the compensation control line, and a second portion arranged on a fourth side of the compensation control line.
the third side and the fourth side are opposite sides.

In the same pixel structure, sections of first portions in pixel circuits adjacent in the second direction are arranged in mirror symmetry with the first direction as an axis line.

Structures of second portions in pixel circuits adjacent in the second direction are the same.

Optionally, the first direction may be a vertical direction, the second direction may be a horizontal direction, the third side may be an upper side, and the fourth side may be a lower side, but the present disclosure is not limited thereto.

In specific implementations, the compensation control line may extend in the second direction, and the pixel driving circuit may include the first portion arranged on the upper side of the compensation control line, and the second portion arranged on the lower side of the compensation control line, in two pixel circuits adjacent in the horizontal direction included in the same pixel structure, structures of the second portions are the same, sections in the first portion are symmetrical with respect to an Y axis. With the design in which some portions of different pixel driving circuits are the same while some portions of different pixel driving circuits are symmetrical, the reference voltage line extending in the longitudinal direction and the reference voltage line extending in the transverse direction can be electrically connected to each other via the connecting conductive pattern located in the same conductive layer.

In at least one embodiment of the present disclosure, one pixel structure may include a red pixel circuit, a green pixel circuit, and a blue pixel circuit.

Optionally, the first portion includes a third transistor. The second portion includes a first transistor, a second transistor, a fourth transistor, a driving transistor and a storage capacitor.

The display substrate includes a light-shielding layer and a source and drain metal layer which are sequentially arranged in a direction away from the base substrate.

The display substrate further includes a first reference voltage line arranged at a third side of the compensation control line, and the first reference voltage line extends in a second direction.

The first reference voltage line is formed in the light-shielding layer, and the second reference voltage line is formed in the source and drain metal layer.

The first reference voltage line is electrically connected to the second reference voltage line through a first connecting conductive pattern formed in the source and drain metal layer.

FIG. 5 is a structural diagram of a pixel repeating unit. As shown in FIG. 5, within a pixel repeating unit, longitudinal wirings from left to right include followings in the sequence listed: ELVDD11, DR1, VR11, DG1, I11, DB1, ELVDD12, DR2, VR12, DG2, I2 and DB2. The longitudinal wirings are all formed in the source and drain metal layer, and there is no connection via hole design on the longitudinal wirings, the space occupied by the longitudinal wirings can be reduced.

In at least one embodiment of the present disclosure, the display substrate may further include a plurality of rows of transverse power supply voltage lines and a plurality of columns of longitudinal power supply voltage lines which are arranged on the base substrate. The plurality of rows of rows of transverse power supply voltage lines and the plurality of rows of columns of longitudinal power supply voltage lines are electrically connected to each other. The transverse power supply voltage line and the longitudinal power supply voltage line are formed in different metal layers.

The display substrate further includes a plurality of rows of transverse reference voltage lines and a plurality of columns of longitudinal reference voltage lines which are arranged on the base substrate. The plurality of rows of transverse reference voltage lines and the plurality of columns of longitudinal reference voltage lines are electrically connected to each other. The transverse reference voltage line and the longitudinal reference voltage line are formed in different metal layers.

In at least one embodiment of the present disclosure, the display substrate further includes a plurality of rows of transverse initial voltage lines and a plurality of columns of longitudinal initial voltage lines which are arranged on the base substrate. The transverse initial voltage line and the longitudinal initial voltage line are formed in different metal layers.

A column of pixel structures includes three columns of pixel circuits, and the column of pixel structures shares a column of longitudinal initial voltage line. A group of pixel structures includes at least one column of pixel structures.

Each row of pixel circuits in the group of pixel structures is electrically connected to the same transverse initial voltage line, and the longitudinal initial voltage line shared by the group of pixel structures and a plurality of rows of transverse initial voltage lines electrically connected to the group of pixel structures are electrically connected to each other.

Optionally, the pixel circuit includes a storage capacitor, a second plate of the storage capacitor includes a first plate portion and a second plate portion.

at least a portion of a first plate of the storage capacitor is located between the first plate portion and the second plate portion in a direction perpendicular to the base substrate.

In at least one embodiment of the present disclosure, the display substrate may include a light-shielding layer, a semiconductor layer and a source and drain metal layer which are arranged in the sequence listed in a direction away from the base substrate;

The first plate may be formed in the semiconductor layer, the first plate portion may be formed in the light-shielding layer, and the second plate portion may be formed in the source and drain metal layer, but this is not limiting.

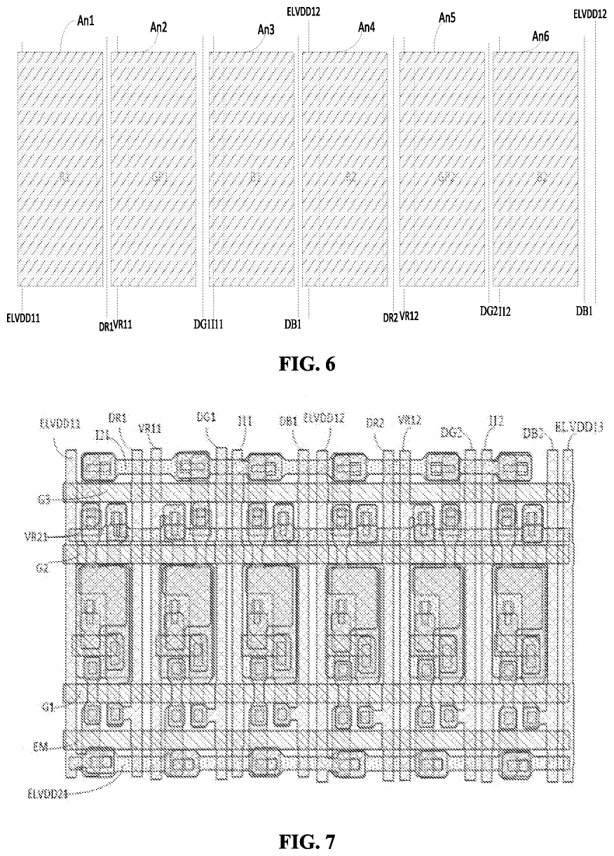

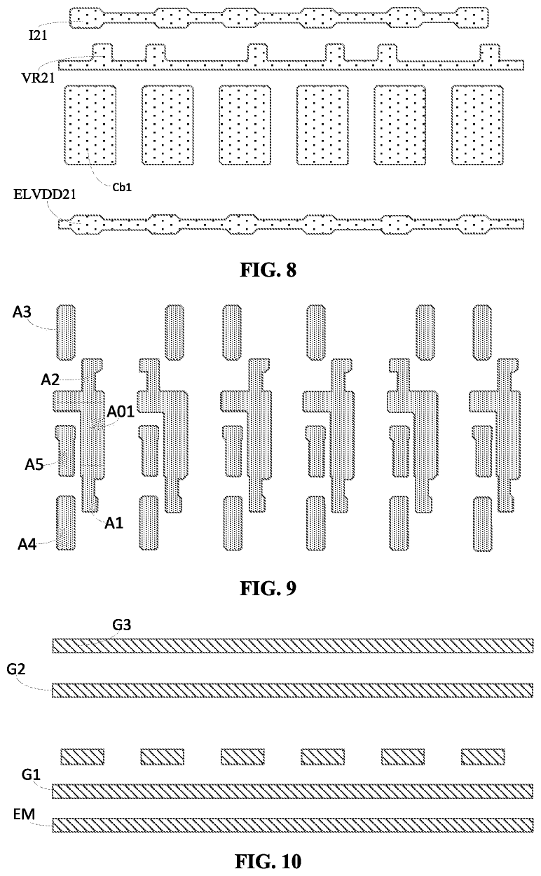

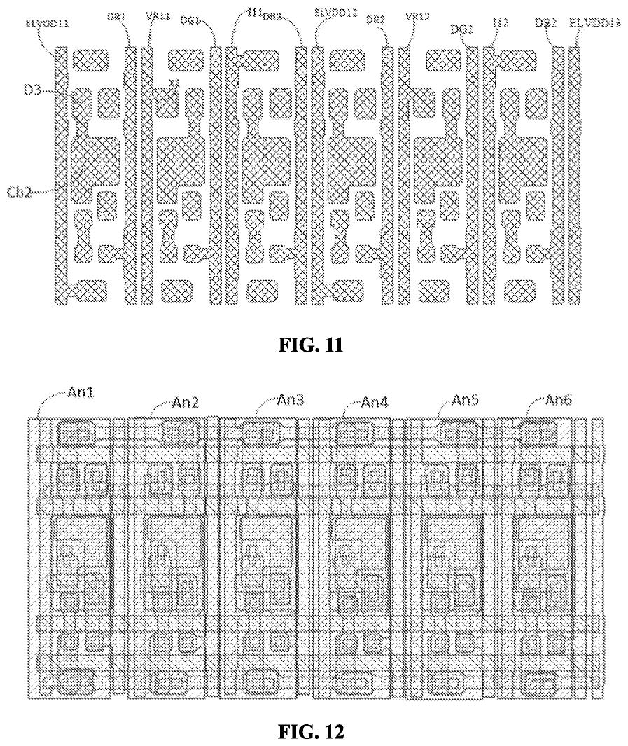

FIG. 7 is a layout diagram of a pixel driving circuit in at least one embodiment. FIG. 8 is a layout diagram of a light-shielding layer in FIG. 7, FIG. 9 is a layout diagram of a semiconductor layer in FIG. 7, FIG. 10 is a layout diagram of a gate metal layer in FIG. 7, and FIG. 11 is a layout diagram of a source and drain metal layer in FIG. 7.

In FIG. 7, six pixel driving circuits are provided.

in FIG. 7, a first red pixel driving circuit, a first green pixel driving circuit, a first blue pixel driving circuit, a second red pixel driving circuit, a second green pixel driving circuit and a second blue pixel driving circuit are provided from left to right in the sequence listed.

As shown in FIG. 7, ELVDD11 is arranged at the left side of the first red pixel driving circuit is provided, and DR1 is arranged at the right side of the first red pixel driving circuit.

ELVDD12 is arranged at the left side of the second red pixel driving circuit, and DR2 is arranged at the right side of the second red pixel driving circuit.

Namely, signals on the signal lines provided at the left side of the red pixel driving circuits are of the same type, and signals on the signal lines provided at the right side of the red pixel driving circuits are of the same type.

VR11 is arranged at the left side of the first green pixel driving circuit, and DG1 is arranged at the right side of the first green pixel driving circuit.

VR12 is arranged at the left side of the second green pixel driving circuit, and DG2 is arranged at the right side of the second green pixel driving circuit.

Namely, signals on the signal lines provided at the left side of the green pixel driving circuits are of the same type, and signals on the signal lines provided at the right side of the green pixel driving circuits are of the same type.

I11 is arranged at the left side of the first blue pixel driving circuit, and DB1 is arranged at the right side of the first blue pixel driving circuit.

I12 is arranged at the left side of the second blue pixel driving circuit, and DB2 is arranged at the right side of the second green pixel driving circuit.

Namely, signals on the signal lines provided at the left side of the blue pixel driving circuits are of the same type, and signals on the signal lines provided at the right side of the blue pixel driving circuits are of the same type.

As shown in FIG. 7, a direct current signal line is used to separate adjacent pixel driving circuits, so as to reduce coupling interference between adjacent pixel driving circuits.

In FIG. 7, reference sign G3 is a reset control line, reference sign G2 is a compensation control line, reference sign G1 is a write control line, reference sign EM is a light-emitting control line, reference sign I21 is a first transverse initial voltage line, reference sign VR21 is a first transverse reference voltage line, and reference sign ELVDD21 is a first transverse power supply voltage line.

As shown in FIG. 10, G3, G2, G1 and EM are formed in the gate metal layer. In FIG. 10, reference sign G5 denotes a gate electrode of the driving transistor.

As shown in FIG. 8, I21, VR21 and ELVDD21 are formed in the light-shielding layer.

ELVDD11, DR1, VR11, DG1, I11, DB1, ELVDD12, DR2, VR12, DG2, I2 and DB2 are formed in the source and drain metal layer.

In FIG. 9, reference sign A1 denotes an active pattern of the first transistor, reference sign A2 denotes an active pattern of the second transistor, reference sign A3 denotes an active pattern of the third transistor, reference sign A4 denotes an active pattern of the fourth transistor, and reference sign A5 denotes an active pattern of the driving transistor.

A1 and A2 are connected with each other, and reference sign A01 is a first active pattern; the first active pattern A01 is reused as a first plate of the storage capacitor; and the first active pattern A01 is electrically connected to a gate electrode G5 of the driving transistor.

In FIG. 8, reference sign Cb1 is a first plate portion included in a second plate of the storage capacitor, and reference sign Cb2 is a second plate portion included in the second plate of the storage capacitor.

In the layout of the pixel driving circuit as shown in FIG. 7 of the present disclosure, Cb1 and Cb2 are respectively located on the upper side and the lower side of the first plate of the storage capacitor, so as to increase the capacitance value of the storage capacitor.

FIG. 12 is a layout on the basis of FIG. 11 in which a first electrode layer, which may be an anode layer, is provided.

In FIG. 12, reference sign An1 denotes a first anode pattern, reference sign An2 denotes a second anode pattern, reference sign An3 denotes a third anode pattern, reference sign An4 denotes a fourth anode pattern, reference sign An5 denotes a fifth anode pattern, and reference sign An6 denotes a sixth anode pattern.

An1 covers the first red pixel driving circuit and the ELVDD11 at the left side of the first red pixel driving circuit.

An2 covers the first green pixel driving circuit and VR11 at the left side of the first green pixel driving circuit.

An3 covers the first blue pixel driving circuit and I11 at the left side of the first blue pixel driving circuit.

An4 covers the second red pixel driving circuit and the ELVDD12 at the left side of the second red pixel driving circuit.

An5 covers the second green pixel driving circuit and VR12 at the left side of the second green pixel driving circuit.

An6 covers the second blue pixel driving circuit and I12 at the left side of the second blue pixel driving circuit.

In at least one embodiment of the present disclosure, the anode pattern does not overlap with adjacent pixel driving circuits on the left and right side, and does not overlap with the pixel driving circuits in upper and lower rows. Each anode pattern only covers a corresponding pixel driving circuit electrically connected thereto and a direct current signal line adjacent to the corresponding pixel driving circuit, but does not cover a data line (a data voltage on the data line is a high frequency alternating current signal), so that the coupling effect can be greatly reduced and the compensation effect can be improved.

In the related art, the hole for jointing anode is designed to be located at a position in the middle of the pixel driving circuit where the storage capacitor is located, as a result, the anode pattern may cover a plurality of pixel driving circuits. In this regard, in at least one embodiment of the present disclosure, via holes for the anode is designed to be at the end of the second electrode of the third transistor.

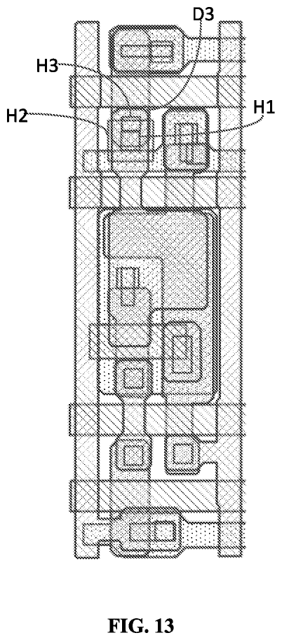

As shown in FIG. 13, reference sign H1 is a first via hole, and reference sign H2 is a second via hole.

A second electrode of the third transistor is electrically connected to the anode pattern (not shown in FIG. 13) via the first via hole H1 penetrating through the first insulating layer, and the second via hole H2 penetrating through the second insulating layer successively.

The second electrode of the third transistor is formed in the source and drain metal layer, and the anode pattern is formed in the first electrode layer; the display substrate includes the source and drain metal layer, a first insulating layer, a second insulating layer and the first electrode layer which are arranged in a direction away from base substrate in the sequence listed, where the first insulating layer may be a passivation layer and the second insulating layer can be an organic insulating layer.

An orthographic projection of the first via hole H1 onto the base substrate may fall within an orthographic projection of the second via hole H2 onto the base substrate.

A maximum length of the second via hole H2 in the horizontal direction is greater than a maximum length of the second electrode D3 of the third transistor in the horizontal direction.

In FIG. 13, reference sign H3 is the third via hole, and the third via hole H3 is a via hole penetrating through a third insulating layer (the third insulating layer can be an interlayer dielectric layer) for electrically connecting the second electrode D3 of the third transistor and the active pattern of the third transistor. A portion of the orthographic projection of H3 onto the base substrate is located within the orthographic projection of H2 onto the base substrate.

In FIG. 11, reference sign D3 is the second electrode of the third transistor.

In the related art, two layers of metal connected by a via hole are required to ensure that both layers of metal are larger than the via hole size after etching is completed, i.e., the via hole should be enclosed, while the maximum size of the pattern is often limited when the pixel resolution is high. In at least one embodiment of the present disclosure, based on the requirement on resolution, a transverse dimension of the second electrode D3 of the third transistor formed in the source and drain metal layer cannot be too large. Therefore, in at least one embodiment of the present disclosure, the maximum length of the second via hole H2 in the horizontal direction is greater than the maximum length of the second electrode D3 of the third transistor in the horizontal direction; and a maximum length of the second via hole H2 in the vertical direction is less than a maximum length of the second electrode D3 of the third transistor in the vertical direction. A first electrode layer is fabricated after both the source and drain metal layer and the via holes are fabricated (the first electrode layer may be an anode layer). There may be a small groove region in the first electrode layer at a portion around the second via hole H2. When the groove region is formed, since there is no passive drain metal layer and no organic insulating layer at the bottom of this region. In addition, there may also be a groove formed by the third via hole penetrating through the interlayer dielectric layer at the upper side of the joint holes for the anode. Therefore, the first electrode layer is subjected to multiple climbing slopes at these three points, which may have a certain influence on the anode jointing effect. At the lower side of the joint holes for the anode, the jointing between the first electrode layer and the source and drain metal layer may be normal, and the first electrode layer climbs up joint sleeve holes for the anode (which includes the first via hole and the second via hole), which can ensure that the first electrode of the light-emitting element (the light-emitting element can be an organic light-emitting diode, and the first electrode of the light-emitting element can be an anode) is electrically connected to the second electrode of the third transistor. By the above design, space can be greatly saved while ensuring the potential at the first electrode of the light-emitting element to be normal, so that a high-resolution pixel circuit design with internal compensation may be achieved.

As shown in FIG. 7, structures of various pixel driving circuits under the compensation control line G2 are the same.

Above the compensation control line G2, in one pixel structure (one pixel structure includes a red pixel circuit, a green pixel circuit and a blue pixel circuit which are located in the same row), a part of elements included in adjacent pixel driving circuits is symmetrical with respect to the Y axis, and such a design in which part of the adjacent pixel driving circuits are the same and the other part of the adjacent pixel driving circuits is in symmetry can enable the longitudinal reference voltage line to be electrically connected to the horizontal reference voltage line through the connecting conductive pattern formed in the source and drain metal layer.

As shown in FIGS. 7 to 11, VR11 and a first connecting conductive pattern X1 formed in the source and drain metal layer are formed as one-piece structure, and the first connecting conductive pattern X1 is electrically connected to a first transverse reference voltage line VR21 through a via hole.

In at least one embodiment of the present disclosure, the power supply voltage lines adopt a mesh design that ensures that the power supply voltage delivered by the power supply voltage lines is not affected when there is an open (disconnection) in the power supply voltage line in the AA region (active display area). Namely, according to at least one embodiment of the present disclosure, all the transverse power supply voltage lines and all the longitudinal power supply voltage lines included in the display substrate are electrically connected to each other.

The reference voltage lines also adopt a mesh design, and since the current on the reference voltage line is relatively small, it can be inputted through Bus Line (bus bar). Namely, according to at least one embodiment of the present disclosure, all transverse reference voltage lines and all longitudinal reference voltage lines included in the display substrate are electrically connected with each other and receive an external reference voltage via at least one external reference voltage supply line.

In at least one embodiment of the present disclosure, the initial voltage lines adopt a non-mesh design, one transverse initial voltage line may drive two pixel structures, each pixel structure includes a red pixel circuit, a green pixel circuit, and a blue pixel circuit. Six columns of pixel circuits share two columns of longitudinal initial voltage lines, six columns of pixel circuits in each row is electrically connected to one transverse initial voltage line, the two columns of longitudinal initial voltage lines are electrically connected to a plurality of rows of transverse initial voltage lines electrically connected to the six columns of pixel circuits. This design of the initial voltage line can reduce the influence of large current on the initial voltage lines and the initial voltage lines can also be used as sense lines (detection lines) for the external compensation. In one pixel structure, one column of longitudinal initial voltage line is electrically connected to one pixel structure, and in a fanout region, two columns of longitudinal initial voltage lines are connected together to receive a corresponding initial voltage signal, so as to reduce the quantity of IC (integrated circuit) Pin (pins).

In specific implementations, a pixel definition layer is provided on a side of the first electrode layer away from the base substrate, the pixel definition layer has openings therein, the openings expose at least part of various anode patterns.

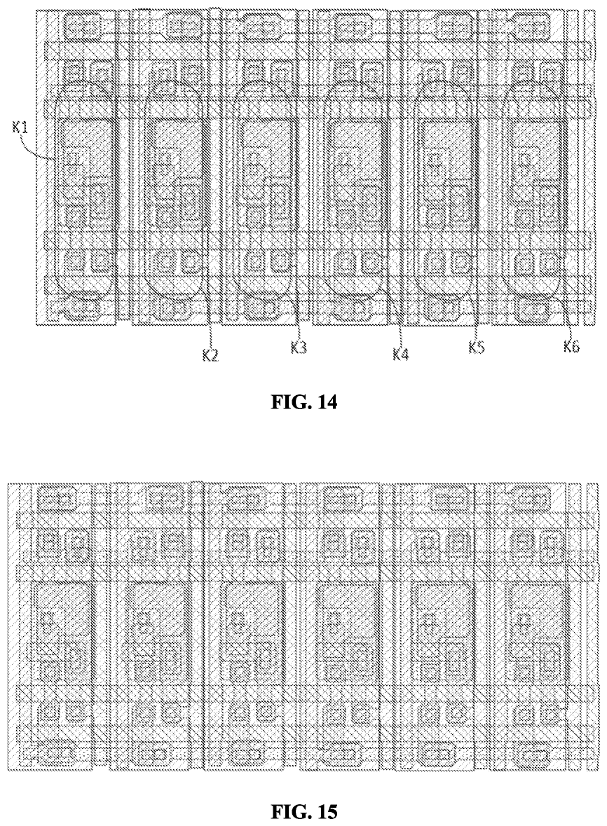

As shown in FIG. 14, on the basis of at least one embodiment of the display substrate shown in FIG. 12, a pixel definition layer is provided on a side of the first electrode layer away from the base substrate, where a first opening is denoted by reference sign K1, a second opening is denoted by reference sign K2, a third opening is denoted by reference sign K3, a fourth opening is denoted by reference sign K4, a fifth opening is denoted by reference sign K5, a sixth opening is denoted by reference sign K6. The first opening K1 exposes a portion of An1, the second opening K2 exposes a portion of An2, the third opening K3 exposes a portion of An3, and the fourth opening K4 exposes a portion of An4; the fifth opening K5 exposes a portion of An5, and the sixth opening K6 exposes a portion of An6.

In specific implementations, when the pixel definition layer has openings with different sizes, the pixel circuit with the largest opening can be arranged to be close to the power supply voltage line, and the width of the power supply voltage line can be adjusted while adjusting the size of the opening, so as to meet the design requirement that the anode pattern only covers the direct current signal line.

In at least one embodiment of the present disclosure, the display substrate includes a first electrode layer and a pixel definition layer arranged in a direction away from the base substrate in the sequence listed. The display substrate further includes a dummy pixel circuit arranged on the base substrate; the dummy pixel circuit includes a dummy organic light-emitting diode.

Openings included in the pixel definition layer does not expose an anode of the dummy organic light-emitting diode, the anode of the dummy organic light-emitting diode is formed at the first electrode layer; or the dummy pixel circuit does not include an anode pattern; or

the dummy pixel circuit further includes at least one transistor; the anode of the dummy organic light-emitting diode is not electrically connected to the transistor included in the dummy pixel circuit.

In specific implementation, the display substrate may be provided with a dummy pixel circuit on at least one of an upper side, a lower side, a left side and a right side of the display area, and the dummy pixel circuit may include a dummy organic light-emitting diode to ensure better driving and displaying of the AA region, and the dummy pixel circuit generally does not emit light.

According to a specific embodiment, as shown in FIG. 15, openings included in the pixel definition layer do not expose the anode of the dummy organic light-emitting diode, and all driving signals are normal.

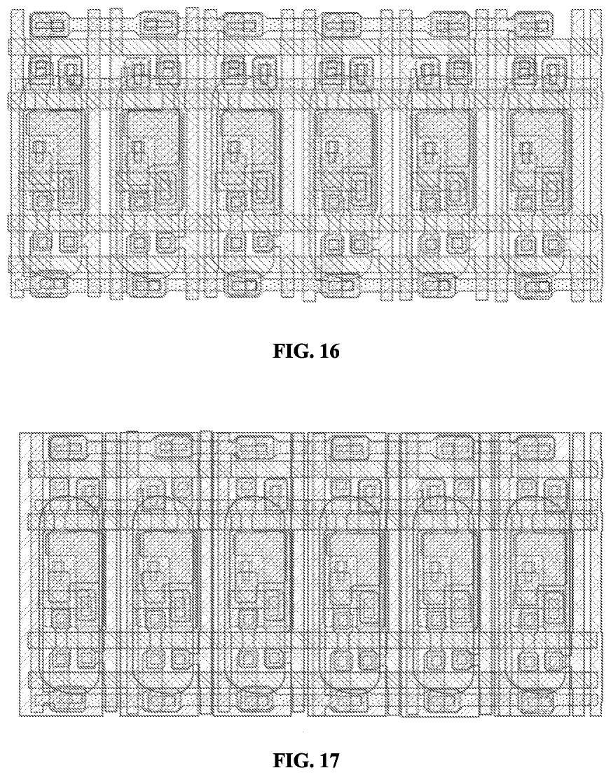

According to another specific embodiment, as shown in FIG. 16, the dummy pixel circuit does not include an anode pattern, and the dummy organic light-emitting diode does not emit light.

According to yet another specific embodiment, as shown in FIG. 17, in the dummy pixel circuit, the anode of the dummy organic light-emitting diode is not electrically connected to the transistor in the dummy pixel circuit, the anode pattern is normal, but no signal is inputted to the anode pattern.

According to an embodiment of the present disclosure, a display panel includes the above-described display substrate.

In at least one embodiment of the present disclosure, the display substrate includes a plurality of write control lines, a plurality of compensation control lines, a plurality of light-emitting control lines and a plurality of reset control lines.

at least two rows of pixel circuits included in the display substrate share one compensation control line, the at least two rows of pixel circuits share one light-emitting control line, and the at least two rows of pixel circuits share one reset control line.

When the display panel according to at least one embodiment of the present disclosure is in operation, a driving waveform can be adjusted according to actual requirements, and a driving scheme without PWM dimming can be adopted when there is a small change in device characteristics during the actual displaying process.

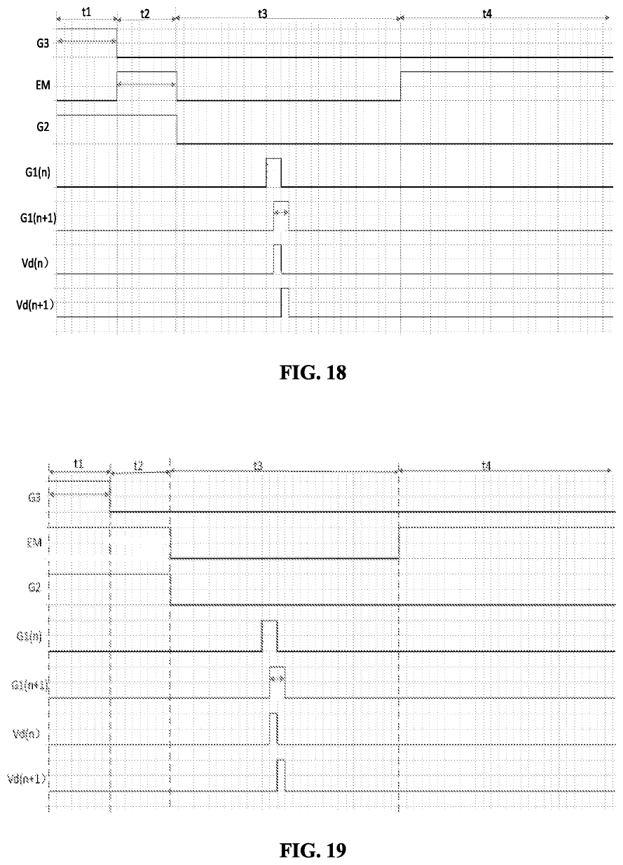

When two adjacent rows of pixel circuits share one compensation control line G2, one reset control line G3 and one light-emitting control line EM, waveforms of various signals may be illustrated in FIG. 18.

In FIG. 18, reference sign G1(n) is the n-th write control line, reference sign G1(n+1) is the (n+1)-th write control line, reference sign Vd(n) is the n-th data voltage, and reference sign Vd (n+1) is the (n+1)-th data voltage; N is a positive integer.

In FIG. 18, reference sign t1 is a reset phase t1, reference sign t2 is a compensation phase, reference sign t3 is a data writing phase, and reference sign t4 is a light-emitting phase.

In specific implementations, when the reset phase t1 lasts for a short time period, as shown in FIG. 19, EM may output a high voltage signal in the compensation phase t2, thereby reducing the quantity of switching operations of the light-emitting control line.

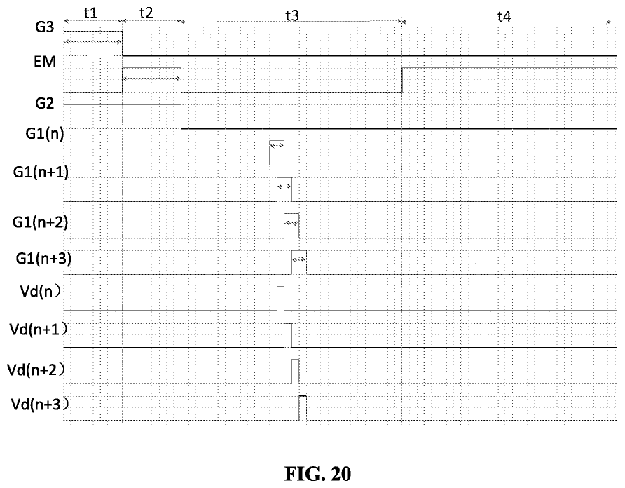

When four adjacent rows of pixel circuits share one compensation control line G2, one reset control line G3 and one light-emitting control line EM, waveforms of various signals may be illustrated in FIG. 20.

In FIG. 20, the reference sign G1(n) is an n-th write control line, the reference sign G1(n+1) is an (n+1)-th write control line, the reference sign G1(n+2) is an (n+2)-th write control line, and the reference sign G1(n+3) is an (n+3)-th write control line.

Reference sign Vd (n) is the n-th data voltage, and reference sign Vd (n+1) is the (n+1)-th data voltage; reference sign Vd(n+2) is an (n+2)-th data voltage, and reference sign Vd(n+3) is an (n+3)-th data voltage.

N is a positive integer.

In FIG. 20, reference sign t1 is a reset phase t1, reference sign t2 is a compensation phase, reference sign t3 is a data writing phase, and reference sign t4 is a light-emitting phase.

According to an embodiment of the present disclosure, the display device includes the above-described display panel.

The display device provided by the embodiments of the present disclosure may be a mobile phone, a tablet computer, a television, a display, a notebook computer, a digital photo frame, a navigator, or any product or component with display functions.

While the foregoing is directed to exemplary embodiments of the present disclosure, it will be understood by those skilled in the art that numerous modifications and adaptations may be made without departing from the principles of the disclosure, and such modifications and adaptations fall within the scope of the disclosure.

1. A pixel circuit, comprising: a light-emitting element and a pixel driving circuit, wherein the pixel driving circuit comprises a driving circuit, a data writing circuit and a compensation control circuit;
the data writing circuit is electrically connected to a write control line, a data line and a control end of the driving circuit, and the data writing circuit is configured to write a data voltage provided by the data line into the control end of the driving circuit under control of a write control signal provided by the write control line in a data writing phase;
the compensation control circuit is electrically connected to a compensation control line, a reference voltage line and the control end of the driving circuit, and the compensation control circuit is configured to write a reference voltage provided by the reference voltage line into the control end of the driving circuit under control of a compensation control signal provided by the compensation control line in a compensation phase;
the driving circuit is electrically connected to the light-emitting element, and the driving circuit is configured to drive the light-emitting element; and
the data writing phase does not overlap with the compensation phase.

2. The pixel circuit according to claim 1, wherein the pixel driving circuit further comprises a light-emitting control circuit;
the light-emitting control circuit is electrically connected to a light-emitting control line, a first end of the driving circuit and a first voltage line, and the light-emitting control circuit is configured to a control connection between the first end of the driving circuit and the first voltage line under control of a light-emitting control signal provided by the light-emitting control line; and
a second end of the driving circuit is electrically connected to a first electrode of the light-emitting element, and a second electrode of the light-emitting element is electrically connected to a second voltage line.

3. The pixel circuit according to claim 2, wherein the pixel driving circuit further comprises a reset circuit;
the reset circuit is electrically connected to a reset control line, an initial voltage line and the second end of the driving circuit, and the reset circuit is configured to write an initial voltage provided by the initial voltage line into the second end of the driving circuit under control of a reset control signal provided by the reset control line in a reset phase.

4. The pixel circuit according to claim 3, wherein at least a portion of a time period during which the light-emitting control circuit controls the first end of the driving circuit to be connected to the first voltage line does not overlap with the reset phase.

5. The pixel circuit according to claim 3, wherein the pixel driving circuit further comprises an energy storage circuit;
a first end of the energy storage circuit is electrically connected to the control end of the driving circuit, a second end of the energy storage circuit is electrically connected to the second end of the driving circuit, and the energy storage circuit is configured to store electric energy.

6. The pixel circuit according to claim 5, wherein the data writing circuit comprises a first transistor, the compensation control circuit comprises a second transistor, the reset circuit comprises a third transistor, the light-emitting control circuit comprises a fourth transistor, the driving circuit comprises a driving transistor, and the energy storage circuit comprises a storage capacitor; the light-emitting element comprises an organic light-emitting diode;
a gate electrode of the first transistor is electrically connected to the write control line, a first electrode of the first transistor is electrically connected to the data line, and a second electrode of the first transistor is electrically connected to a gate electrode of the driving transistor;
a gate electrode of the second transistor is electrically connected to the compensation control line, a first electrode of the second transistor is electrically connected to the reference voltage line, and a second electrode of the second transistor is electrically connected to the gate electrode of the driving transistor;
a gate electrode of the third transistor is electrically connected to the reset control line, a first electrode of the third transistor is electrically connected to the initial voltage line, and a second electrode of the third transistor is electrically connected to a second electrode of the driving transistor;
a gate electrode of the fourth transistor is electrically connected to the light-emitting control line, a first electrode of the fourth transistor is electrically connected to the first voltage line, and a second electrode of the fourth transistor is electrically connected to a first electrode of the driving transistor;
the second electrode of the driving transistor is electrically connected to an anode of the organic light-emitting diode, and a cathode of the organic light-emitting diode is electrically connected to the second voltage line; and
a first plate of the storage capacitor is electrically connected to the gate electrode of the driving transistor, and a second plate of the storage capacitor is electrically connected to the second electrode of the driving transistor.

7. A driving method, applied to the pixel circuit according to claim 1, wherein a displaying period comprises the data writing phase and the compensation phase; the driving method comprises:
writing, in the data writing phase by the data writing circuit, the data voltage provided by the data line into the control end of the driving circuit under control of the write control signal; and
writing, in the compensation phase by the compensation control circuit, the reference voltage provided by the reference voltage line into the control end of the driving circuit under control of the compensation control signal; and
driving, by the driving circuit, the light-emitting element;
wherein the data writing phase does not overlap with the compensation phase.

8. The driving method according to claim 7, wherein the displaying period further comprises a light-emitting phase arranged after the data writing phase and the compensation phase; the pixel driving circuit further comprises a light-emitting control circuit; the driving method comprises:
controlling, in the light-emitting phase by the light-emitting control circuit, a first end of the driving circuit to be connected to a first voltage line under control of a light-emitting control signal;
wherein in the light-emitting phase, the light-emitting control signal is a pulse width modulation (PWM) signal.

9. A display substrate, comprising a base substrate and a plurality of rows of pixel circuits and a plurality of columns of pixel circuits disposed on the base substrate, each pixel circuit of which comprising: a light-emitting element and a pixel driving circuit, wherein the pixel driving circuit comprises a driving circuit, a data writing circuit and a compensation control circuit;
the data writing circuit is electrically connected to a write control line, a data line and a control end of the driving circuit, and the data writing circuit is configured to write a data voltage provided by the data line into the control end of the driving circuit under control of a write control signal provided by the write control line in a data writing phase;
the compensation control circuit is electrically connected to a compensation control line, a reference voltage line and the control end of the driving circuit, and the compensation control circuit is configured to write a reference voltage provided by the reference voltage line into the control end of the driving circuit under control of a compensation control signal provided by the compensation control line in a compensation phase;
the driving circuit is electrically connected to the light-emitting element, and the driving circuit is configured to drive the light-emitting element; and
the data writing phase does not overlap with the compensation phase.

10. The display substrate according to claim 9, wherein an orthographic projection of a first electrode of a light-emitting element comprised in the pixel circuit onto the base substrate covers an orthographic projection of at least part of elements comprised in the pixel driving circuit of the pixel circuit onto the base substrate.

11. The display substrate according to claim 10, further comprising: a plurality of direct current signal lines arranged on the base substrate, wherein the plurality of direct current signal lines extends in a first direction;
at least one direct current signal line of the plurality of direct current signal lines is provided between pixel driving circuits comprised in two adjacent pixel circuits in a second direction;
the first direction intersects with the second direction; and
the orthographic projection of the first electrode of the light-emitting element onto the base substrate covers an orthographic projection of the at least one direct current signal line onto the base substrate.

12. (canceled)

13. The display substrate according to claim 11, further comprising a plurality of data lines arranged on the base substrate, wherein the plurality of data lines extends in the first direction;
a data line of the plurality of data lines is provided between pixel driving circuits comprised in two adjacent pixel circuits in the second direction; and
the orthographic projection of the first electrode of the light-emitting element onto the base substrate does not cover an orthographic projection of the data line onto the base substrate.

14. The display substrate according to claim 13, wherein signals on signal lines, located at a first side of pixel driving circuits of pixel circuits corresponding to a same color and being closest to the pixel driving circuits, have a same type, and signals on signal lines, located at a second side of the pixel driving circuits of the pixel circuits corresponding to the same color and being closest to the pixel driving circuits, have a same type; and
the first side and the second side are opposite sides.

15. The display substrate according to claim 10, wherein the pixel driving circuit comprises a reset circuit, and the reset circuit comprises a third transistor;
the first electrode of the light-emitting element is electrically connected to a second electrode of the third transistor through via holes;
a maximum length of at least one via hole in a second direction is greater than a maximum length of the second electrode of the third transistor in the second direction.

16. The display substrate according to claim 15, wherein
the display substrate comprises a source and drain metal layer, a first insulating layer, a second insulating layer and a first electrode layer which are arranged sequentially in a direction away from the base substrate;
the first electrode of the light-emitting element is located in the first electrode layer, and the second electrode of the third transistor is located in the source and drain metal layer;
the second electrode of the third transistor is electrically connected to the first electrode of the light-emitting element via a first via hole penetrating through the first insulating layer and a second via hole penetrating through the second insulating layer successively;
an orthographic projection of the first via hole onto the base substrate is within an orthographic projection of the second via hole onto the base substrate; and
a maximum length of the second via hole in the second direction is greater than a maximum length of the second electrode of the third transistor in the second direction.

17. (canceled)

18. The display substrate according to claim 11, the display substrate further comprising: a plurality of first reference voltage lines extending in the second direction, and a plurality of second reference voltage lines extending in the first direction which are arranged on the base substrate; and
the first reference voltage line is electrically connected to the second reference voltage line through a connecting conductive pattern located in a same conductive layer;
and/or
the display substrate further comprising: a plurality of transverse power supply voltage lines and a plurality of longitudinal power supply voltage lines which are arranged on the base substrate, wherein the plurality of transverse power supply voltage lines and the plurality of longitudinal power supply voltage lines are electrically connected to each other; and the plurality of transverse power supply voltage lines and the plurality of longitudinal power supply voltage lines are located in different metal layers; and
the display substrate further comprises a plurality of transverse reference voltage lines and a plurality of longitudinal reference voltage lines which are arranged on the base substrate, wherein the plurality of transverse reference voltage lines and the plurality of longitudinal reference voltage lines are electrically connected to each other; and the plurality of transverse reference voltage lines and the plurality of longitudinal reference voltage lines are located in different metal layers.

19. (canceled)

20. The display substrate according to claim 10, wherein
the display substrate further comprises a plurality of transverse initial voltage lines and a plurality of longitudinal initial voltage lines which are arranged on the base substrate; the plurality of transverse initial voltage line and the plurality of longitudinal initial voltage line are located in different metal layers;
one column of pixel structures comprises three columns of pixel circuits, and one column of pixel structures share one longitudinal initial voltage line; one group of pixel structures comprises at least one column of pixel circuits;
each row of pixel circuits in one group of pixel structures is electrically connected to a same transverse initial voltage line, and a longitudinal initial voltage line shared by the one group of pixel structures is electrically connected to a plurality of transverse initial voltage lines to which the one group of pixel structures is electrically connected.

21. The display substrate according to claim 9, wherein the pixel circuit comprises a storage capacitor; a second plate of the storage capacitor comprises a first plate portion and a second plate portion; and
in a direction perpendicular to the base substrate, at least a portion of the first plate of the storage capacitor is located between the first plate portion and the second plate portion.

22. The display substrate according to claim 21, wherein the display substrate comprises a first electrode layer and a pixel definition layer which are arranged sequentially in a direction away from the base substrate; the display substrate further comprises a dummy pixel circuit arranged on the base substrate; the dummy pixel circuit comprises a dummy organic light-emitting diode;
openings included in the pixel definition layer does not expose an anode of the dummy organic light-emitting diode, and the anode of the dummy organic light-emitting diode is located in the first electrode layer; or
the dummy pixel circuit does not comprise an anode pattern; or
the dummy pixel circuit further comprises at least one transistor; the anode of the dummy organic light-emitting diode is not electrically connected to the at least one transistor comprised in the dummy pixel circuit.

23. A display panel, comprising a display substrate, the display substrate comprising a base substrate and a plurality of rows of pixel circuits and a plurality of columns of pixel circuits disposed on the base substrate, each pixel circuit of which comprising: a light-emitting element and a pixel driving circuit, wherein the pixel driving circuit comprises a driving circuit, a data writing circuit and a compensation control circuit;
the data writing circuit is electrically connected to a write control line, a data line and a control end of the driving circuit, and the data writing circuit is configured to write a data voltage provided by the data line into the control end of the driving circuit under control of a write control signal provided by the write control line in a data writing phase;
the compensation control circuit is electrically connected to a compensation control line, a reference voltage line and the control end of the driving circuit, and the compensation control circuit is configured to write a reference voltage provided by the reference voltage line into the control end of the driving circuit under control of a compensation control signal provided by the compensation control line in a compensation phase;
the driving circuit is electrically connected to the light-emitting element, and the driving circuit is configured to drive the light-emitting element; and
the data writing phase does not overlap with the compensation phase;
wherein the display substrate comprises a plurality of write control lines, a plurality of compensation control lines, a plurality of light-emitting control lines and a plurality of reset control lines;
at least two rows of pixel circuits comprised in the display substrate share one compensation control line, the at least two rows of pixel circuits share one light-emitting control line, and the at least two rows of pixel circuits share one reset control line.

24. (canceled)

25. (canceled)
